(19) United States
(12) Patent Application Publication
(10) Pub. No.: US 2005/0259453 A1
(43) Pub. Date: Nov. 24, 2005

(54) Switching capacitor network auxiliary voltage source for off-line IC chip

(76) Inventor: Da Feng Weng, Cupertino, CA (US)

Correspondence Address: Da Feng Weng;#4, 20689 Park Circle West, Cupertino, CA, 95014, US

(21) Appl. No.: 10/849,930

(22) Filed: May 21, 2004

(51) Int. Cl. H02M 3/18

(52) U.S. Cl. 363/60

(57) ABSTRACT

A switching capacitor network auxiliary voltage source for IC chip solution is provided. The solution can convert the high DC bus voltage into the low DC voltage in low cost and in high efficiency. The auxiliary voltage is independent of the power converter system duty-cycle.

### BACKGROUND OF THE INVENTION

The present invention relates to the auxiliary voltage source for the off-line IC chip. More particularly, the invention relates to a new concept to generate auxiliary voltage sources for the off-line IC chip.

For off-line power supply application, due to a high DC bus after AC/DC power stage, it is very important to offer an off-line IC chip a suitable auxiliary voltage source V_{cc}, that is, to convert the high DC bus voltage into low DC voltage in low cost and high efficiency.

In existed auxiliary voltage source generating solution, they can be classified as low voltage solution and high voltage solution. In the low voltage solution, there is an additional active device to surfer the high DC bus voltage and an additional auxiliary winding to set up a suitable auxiliary voltage source for the off-line IC chip. In this solution, the auxiliary voltage will be variable with the load or the output voltage due to a duty-cycle issue. The benefit of the solution is that, in the off-line IC chip, there is no high voltage processor required and the chip can be small in size and low in cost. But the total solution cost is still higher due to the additional active device and auxiliary winding. In the high voltage solution, the off-line IC chip has the high voltage processor and the off-line IC chip can directly connect to DC bus rail. The off-line IC chip has a function block to convert the high DC bus voltage into the low DC voltage as the IC chip auxiliary voltage source. The benefit of the solution is simple in the solution and independent of the duty-cycle issue. But the cost of the solution is high due to the high voltage processor and there is a thermal issue with the IC chip due to a high DC bus voltage drop on the chip.

For the low cost solution of the off-line IC chip auxiliary voltage source, it is required that the whole chip with the auxiliary voltage source can be implemented in the regular low voltage processor or no high voltage processor and no thermal issue in the total solution, and the auxiliary voltage source is independent of the duty-cycle.

The present invention is to present a simple solution for the IC chip auxiliary voltage source. It is low cost and independent of the duty-cycle.

### SUMMARY OF THE INVENTION

The present invention discloses a novel switching capacitor auxiliary voltage source solution for the off-line IC chip. In the solution, the off-line power converter circuit, passive circuit and switching capacitor network are used to convert the DC bus voltage into a low DC voltage and regulate the low DC voltage as a suitable auxiliary voltage for the off-line IC chip. It is the passive circuit that there is no tough thermal issue. Due to the switching capacitor operation concept, there is no duty-cycle issue. The present invention fully utilizes the characteristics of the switching power converter to implement the switching capacitor concept.

The solution block diagram is shown in FIG. 1. It is composed of a passive circuit block, a switching capacitor network block, and hysteresis voltage compare block. The passive circuit and switching capacitor network block are used to convert the DC bus voltage into a low DC output voltage Vₒ which is variable with the output load. The hysteresis voltage compare block detects and compares the output voltage Vₒ with the reference voltage, and the output of the hysteresis voltage compare block is used to control the switching capacitor network block and to regulate the output voltage Vₒ. It is the switching capacitor network regulation that the output voltage Vₒ can be independent of the load.

In the switching capacitor operation concept, all energy transfer is based on how high the dv/dt is on the switching capacitors, otherwise saying, any energy transfer is taking place at the exact instant of switching due to high dv/dt on the switching capacitors during the switching capacitors' charging or discharging period. After that instant, as long as the switching capacitors have been charged or discharged completely, due to low di/dt on the switching capacitors, the transferred energy is almost zero. Based on the switching capacitor operation concept, for switching capacitor network, the energy transfer rate is determined by the step voltage, the switching capacitor network's switching frequency and the value of capacitors and is independent of the duty-cycle.

### BRIEF DESCRIPTION OF THE DRAWINGS

FIG. 1 is a general switching capacitor network auxiliary voltage source for the off-line IC chip block diagram of the present invention;

FIG. 2 is one of detailed embodiment of the general switching capacitor network auxiliary voltage source for the off-line IC chip block diagram of the present invention;

FIG. 3 is one timing diagram of embodiment of FIG. 2;

FIG. 4 is the detailed sub-circuit of FIG. 2's switching capacitor network;

FIG. 5 is the expanded waveforms of FIG. 3.

FIG. 6 is the whole self-start process waveforms of the switching capacitor network auxiliary voltage source with capacitor coupled for off-line IC chip.

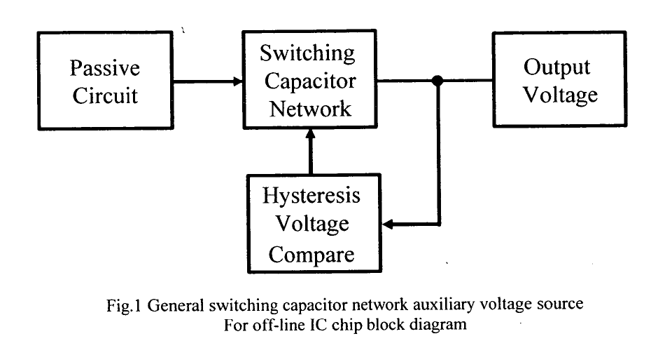

### DETAILED DESCRIPTION OF THE INVENTION

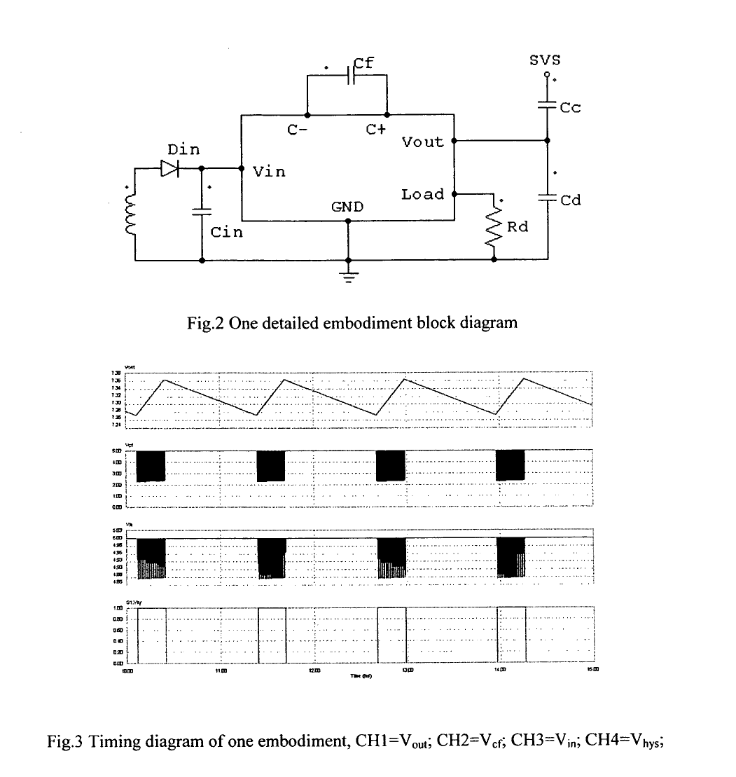

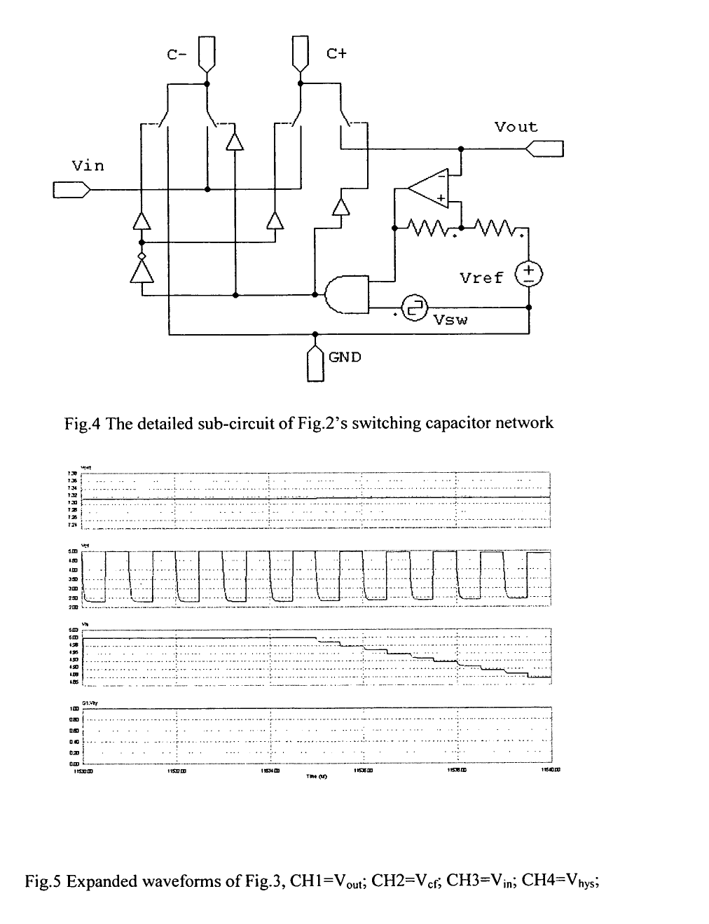

FIG. 2 shows one detailed embodiment of the invention scheme block diagram. In the detailed block diagram, there are four blocks: couple wind passive circuit, switching capacitor network, hysteresis comparator network and an initial start couple circuit which is composed of SVS initial start voltage source, couple capacitor C_{c} and the output capacitor C_{d}. The load resistor R_{d} represents IC chip load and the output load.

In the switching power converter, due to the active switch turn-on or off, there is a switching node. The switching node jumps from zero to the DC rail in high dv/dt. It is the switching node that which its voltage can be coupled through a couple winding. The output of the couple wind passive circuit is used as an input for the switching capacitor network. The amplitude of the input is determined with the turns-ratio of couple windings. In the couple winding passive circuit, the diode Dᵢₙ is used to block the couple winding reset voltage.

In the switching capacitor network, the input voltage is stepped up to an IC operation voltage Vₒ. The IC operation voltage is regulated with the hysteresis comparator network. The switching capacitor network is operated during the time that the IC operation voltage is touched with the bottom of the hysteresis window. The switching capacitor network is stopped also when the IC operation voltage is touched with the top of the hysteresis window. The IC operation voltage Vₒ has a ripple and the ripple amplitude is determined by the hysteresis window.

The hysteresis comparator network is used to set up the hysteresis window based on the reference voltage and feedback resistors. For IC operation, as long as the operation voltage is over the minimum operation, IC has a very good line regulation performance. Due to the time constant of the capacitor C_{d} and the equivalent IC load R_{d}, based on the hysteresis window, the switching capacitor network is operated in PWM mode. All time domain waveforms are shown in FIG. 3.

To consider the start-up process, based on the value of the required output capacitor C_{d} and an initial start up voltage source SVS, a suitable value of the couple capacitor is chosen. As the initial start up voltage source SVS increases due to the divider function of C_{c} and C_{d}, the voltage on C_{d} increases too. As SVS is in steady state, the voltage on C_{d} has reached an initial voltage for IC initial operation.

In this detailed embodiment of the general switching capacitor auxiliary voltage source solution, due to maximum IC pin voltage limitation, the input voltage variation range of the switching capacitor network is from over half of the IC operation voltage Vₒ to Vₘₐₓ, or Vₘₐₓ is the maximum rate voltage of the IC chip. If the input voltage variation range is larger, a higher step ratio switching capacitor network can be used to get more input voltage range. Of course, to pick up a suitable couple winding location, it will help to decrease the input voltage range and help with the whole design work.

Due to the regulation of the switching capacitor network, the auxiliary voltage source can offer a constant voltage for IC chip operation from a wide range input source. Due to the couple winding function, it can be overcome to surfer a high DC bus voltage and to convert the high DC bus voltage into a low DC voltage.

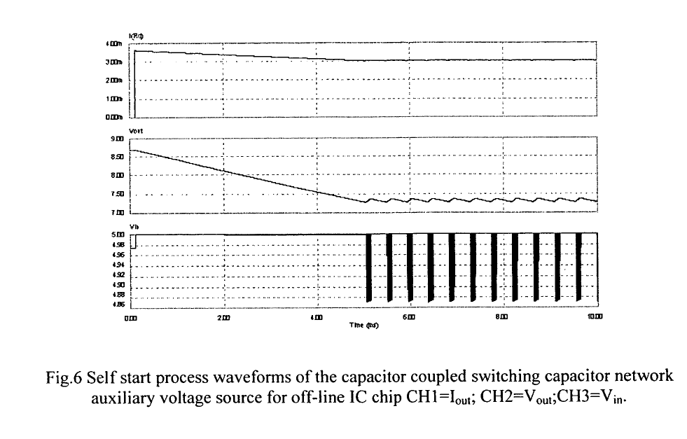

To self-start the whole switching capacitor network auxiliary voltage source system for off-line IC chip, it is necessary to have an initial voltage on the output capacitor C_{d} of the switching capacitor network, or off-line IC chip's Vₒ capacitor C_{d}. Due to IC chip's UVLO function, to get the initial voltage on the Vₒ capacitor C_{d}, there are several ways, e.g. high resistor, couple capacitor, etc. For a high resistor, due to a power dissipation issue, the value of the resistor should be much higher and the problem with the higher resistor value is longer charging time to reach the initial voltage due to the big time constant. For a couple-capacitor C_{c} as shown in FIG. 2, due to no power dissipation issue, it can make the initial voltage set up very quickly. FIG. 6 shows the whole self-start process waveforms of the switching capacitor network auxiliary voltage source with a coupled capacitor C_{c} for the off-line IC chip. As shown in FIG. 6, the initial voltage on the Vₒ capacitor C_{d} is set up immediately and the whole self-start period is determined with the initial voltage Vₒ on the capacitor C_{d} and the time constant of capacitor C_{d} and the equivalent load R_{d} of the IC chip.

In the present invention, due to regulation of the switching capacitor network, the input voltage range of the switching capacitor network can be wider and the off-line IC chip operation voltage Vₒ can be controlled in a constant DC voltage. Due to the low voltage processor in IC, the couple capacitor C_{c} couples for initial start and the passive circuit couples for steady-state operation, the whole system can be low in cost and high in efficiency.

1. Switching capacitor network auxiliary voltage source for the IC chip solution comprising:
Passive circuit block for converting the high DC bus voltage into a suitable low DC input voltage; and
Switching capacitor network block for converting the low DC input voltage to a fixed IC operation voltage; and
Hysteresis voltage compare block for detecting the difference between the IC operation voltage and the reference voltage and regulating the switching capacitor network.

2. Switching capacitor network auxiliary voltage source for IC chip solution claim 1, wherein the passive circuits block can be simple as comprising of a couple winding and a diode and be implemented with more complicate circuit.

3. Switching capacitor network auxiliary voltage source for IC chip solution claim 1, wherein the switching capacitor network block can be simple as a simple switch capacitor network and be implemented with more complicated switching capacitor network.

4. Switching capacitor network auxiliary voltage source for IC chip solution claim 1, wherein the hysteresis voltage compare block can be simple as a comparator and be complete with several complicated compare functions.
